(19) United States
(12) Patent Application Publication
(10) Pub. No.: US 2020/0401690 A1
(43) Pub. Date: Dec. 24, 2020

(54) TECHNIQUES FOR AUTHENTICATING AND SANITIZING SEMICONDUCTOR DEVICES

(71) Applicant: Kameleonsec Inc., Mountain View, CA (US)

(72) Inventors: Jorge MYSZNE, Mountain View, CA (US); Ido NASHTEIN, Karkur (IL); Efi SASSON, Kfar Tavor (IL); Yigal EDERY, Pardessiya (IL)

(73) Assignee: Kameleonsec Inc., Mountain View, CA (US)

(21) Appl. No.: 16/908,263

(22) Filed: Jun. 22, 2020

Related U.S. Application Data
(60) Provisional application No. 62/864,699, filed on Jun. 21, 2019.

(51) Int. Cl. G06F 21/44; G06F 21/73

(52) U.S. Cl. CPC G06F 21/44; G06F 2221/2143; G06F 21/73

(57) ABSTRACT

A sanitization circuit for sanitizing and authenticating a semiconductor device and method thereof are provided. The sanitization circuit is integrated in the semiconductor device and includes a memory verification module configured to verify any pre-programmed memory integrated in the semiconductor device; a memory eraser module configured to erase data stored in at least volatile memory accessed by the semiconductor device; and an implanted circuitry detection module configured to detect any unintended circuitry added to the semiconductor device.

### CROSS-REFERENCE TO RELATED APPLICATIONS

This application claims the benefit of U.S. Provisional Application No. 62/864,699 filed on Jun. 21, 2019, the contents of which are hereby incorporated by reference.

### TECHNICAL FIELD

The present disclosure relates generally to cybersecurity and, more specifically, to the field of architecture, design, and hardware sanitization in order to prevent counterfeiting and ensure hardware authenticity.

### BACKGROUND

Today's semiconductor devices are used for critical tasks, including access control management, security for sensors, computing for wearables and other IoT devices, automotive and aerospace applications, infrastructure systems, servers, data centers, and the like. Such devices require high levels of integrity and authenticity. Authenticity is required to ensure that each system including such semiconductor devices properly operates according to its intended specification. A semiconductor device may be hacked with malicious code or hardware. Further, a counterfeit semiconductor device may not operate at its intended specification, such as, for example, at an “army grade” specification.

The fabrication or manufacture of semiconductor devices, such as integrated circuits (IC) or chips, occurs mostly in locations and facilities with imperfect security which can be breached, or which otherwise cannot be fully trusted. The lack of trust applies to all subsequent phases of the supply chain. As demonstrated in FIG. 4, a supply chain includes programming or designing the device using an electronic design automation (EDA) tool 401, typically providing the RTL code, semiconductor fabrication 402 at a semiconductor fabrication plant, packaging 403 of the IC, testing 403 of the IC at a test house, and assembly of the IC into a product by an original design manufacturer (ODM) 405. Then, the product is shipped to the customer. At any point or phase of the supply chain 400, malevolent actors can tamper with the IC's authentication. For example, malicious code, trojan horse logic, and the like can be added or implemented into the device.

Current solutions for checking authenticity and integrity of a semiconductor device, or integrated circuit (IC), is limited to using secrets implanted in the semiconductor device during the manufacturing process. The secrets are added using either a manufacturer's or customer's provided keys. These keys are later verified at the different stages of the supply chain as part of the authentication process.

The disadvantage of this solution is that the authenticity of overproduced or disqualified semiconductor devices cannot be verified. Such devices are still functional but may have some level of performance degradation, or other minor faults. As such, semiconductor devices may be sold in a gray market and may reach the end customer after tampering. The above-mentioned solutions cannot verify any counterfeit semiconductor device executing properly legitimate logic that also activates malicious code. Malicious code can cause reduced reliability, denial of service, loss of functionality, leakage of sensitive information, and the like. Further, such solutions are limited in their ability to check the integrity of a semiconductor device, that is, check that the device performs as intended.

As there is a high demand to improve the authentication flow of devices and reduce the dependency on a trusted supply chain, it would be advantageous to provide a solution that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a sanitization circuit for sanitizing and authenticating a semiconductor device, wherein the sanitization circuit is integrated in the semiconductor device. The sanitization circuit comprises a memory verification module configured to verify any pre-programmed memory integrated in the semiconductor device; a memory eraser module configured to erase data stored in at least volatile memory accessed by the semiconductor device; and an implanted circuitry detection module configured to detect any unintended circuitry added to the semiconductor device.

Certain embodiments disclosed herein also include a method for sanitizing and authenticating a semiconductor device. The method includes activating the semiconductor device to operate in a sanitization mode; inputting a sanitization challenge; and capturing a sanitization fingerprint in response to the sanitization challenge, wherein the sanitization fingerprint is indicative of the authenticity of the semiconductor device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram of a semiconductor device designed with a sanitization circuit, according to an embodiment.

FIG. 2 is a block diagram of the sanitization circuit according to an embodiment.

FIG. 3 is a flowchart illustrating a method for authenticating and sanitizing a semiconductor device according to an embodiment.

FIG. 4 is a schematic diagram of a supply chain of a semiconductor device.

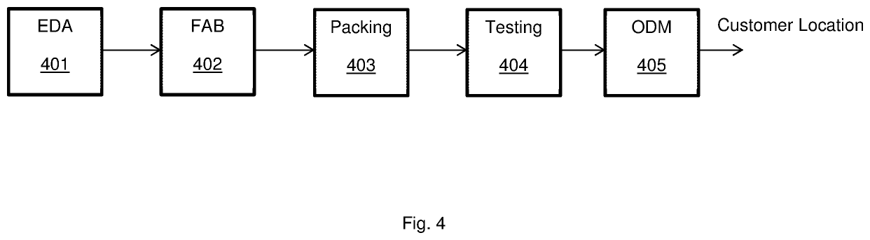

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include techniques that allow for fully authenticating a semiconductor device. The authentication of the semiconductor device can be performed at any stage of the manufacturing supply chain or when the semiconductor device is at the end-customer. The disclosed techniques further allow for mathematically proving the state of the semiconductor device, each of its logic elements, such as memory, logic, and the like, and other devices connected to the semiconductor device.

In an embodiment, the authenticity of the semiconductor device is determined by comparing a generated or other computed sanitization fingerprint to a secured database managed by the semiconductor device's vendor. This would guarantee the semiconductor device's authenticity and trustworthiness without having the customer signing each semiconductor device at the manufacturer site.

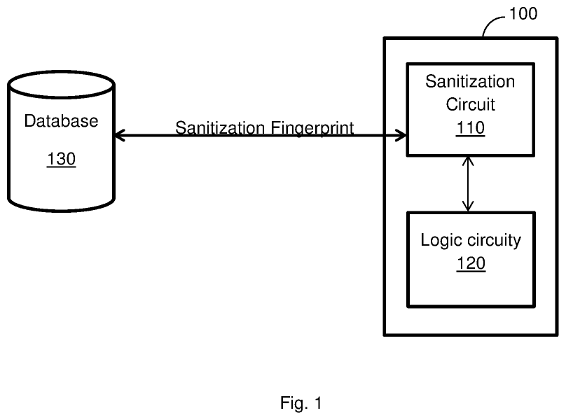

FIG. 1 shows an example diagram of a semiconductor device 100 designed with a sanitization circuit 110, according to an embodiment. The semiconductor device 100 also includes logic circuitry 120 to perform the intended functionality of the semiconductor device 100. Such functionality includes, for example, processing signals, computing data, storing data, and the like. The logic circuitry 120 may include memory units, such as read-only memory (ROM), random-access memory (RAM), registers, and the like, arithmetic units, processing units, gated logic, discrete hardware components, dedicated hardware finite state machines, and the like.

In general, the semiconductor device 100 may include any general-purpose microprocessor, microcontroller, digital signal processor (DSP), field-programmable gate array (FPGA), programmable logic devices (PLD), controller, internet of things (IoT) node, tensor processing unit (TPU), and the like. In a further embodiment, the semiconductor device 100 is a device configured to execute security processes or operate as a co-processor providing security functions to the main processor.

The sanitization circuit 110 is configured to sanitize the semiconductor device and ensure the device's authenticity and integrity. Sanitization of the semiconductor device 100 ensures that no software, firmware, middleware, or hardware has been implanted in the device 100, either by a malicious activity or due to a mistake during any phases of the assembly. The sanitization of the semiconductor device 100 further ensures that the device performs its intended functionality.

As will be discussed in greater detail below, the sanitization circuit 110 is configured to generate a sanitization fingerprint in response to a sanitization challenge. The value of the sanitization is compared against a deterministic value stored in a database 130. The sanitization fingerprint and challenge signals may each include a digital word with a large number of bits, for example, 2\hat{ }256, or two to the power of 256, bits. The sanitization challenge is also a deterministic value. In another embodiment, each pair of sanitization fingerprint and challenge signals are unique for each semiconductor device 100. In an embodiment, the sanitization challenge is computed based on certain specifications of the device's 100 design.

The sanitization process and, hence, the sanitization circuit 110, operates when the semiconductor device 100 is in a sanitization mode. The sanitization mode may utilize a design for test (DFT) mode of the device 100, where functionality of the device is scanned. A DFT mode allows for reducing the difficulty and cost associated with testing an integrated circuit. The sanitization may be, for example, a serial interface, a general-purpose input/output (GPIO), and the like.

The database 130 is a secured database that cannot be hacked or tampered with. In an example, the database 130 may implement a hardware security module (HSM). A HSM is a secure physical device utilized to encrypt data at rest. In another embodiment, the database 130 is a data store configured to archive data permanently or semi-permanently. The database 130 may be configured to store pairs of sanitization challenges and sanitization fingerprint signals. In another embodiment, instead of storing the sanitization fingerprint, the database 130 may compute such signals on-the-fly, responsive to a sanitization challenge.

The database 130 may be a local system, a remote system, or a hybrid remote-local system. Further, the database 130 may be configured as a full-physical system including exclusively physical components, as a virtualized system including virtualized components, or as a hybrid physical-virtual system. The database 130 may be realized as, without limitation, local database hardware, cloud storage systems, remote storage servers, other, like, devices, and any combination thereof. The connection to the database 130 uses a secured protocol over a secured connection.

In an embodiment, the database 130 may be maintained in a customer's location or at a vendor's location. The customer is any entity utilizing the semiconductor device in its product. The vendor is an entity developing and providing the sanitization circuit 110 and the contents of the database 130.

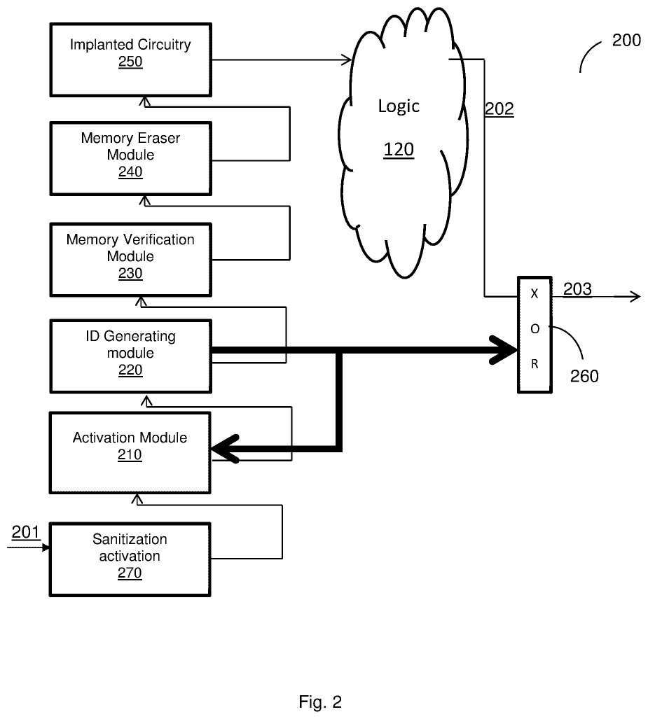

FIG. 2 shows an example block diagram 200 of the sanitization circuit 110 according to an embodiment. The sanitization circuit 110 includes an activation module 210, an identifier generating module 220, a memory verification module 230, a memory eraser module 240, an implanted circuitry detection module 250, as well as a logic XOR gate 260. In an embodiment, the sanitization circuit 110 further includes a sanitization activation module 270 configured to trigger a sanitization mode for the device 100.

The activation module 210 is configured to activate the sanitization circuit 110 and the entire semiconductor device. The activation is in response to a signal received on the semiconductor device's interface, such as a joint test action group (JTAG) interface, a debug interface, or a main interface. The activation of the sanitization circuit 110 starts the sanitization process. In another embodiment, the activation is in response to a unique ID generated using a physical unclonable function (PUF), a password, an encrypted activation sequence, and the like. In another embodiment, the activation may be performed using hardware metering techniques.

The identifier generating module 220 is configured to generate a unique identifier (ID) for the semiconductor device. In an embodiment, the ID is generated using a physical unclonable function (PUF), which is a “digital fingerprint” that serves as a unique identity for a semiconductor device. A PUF is based on slight physical variations that naturally occur during a semiconductor's manufacturing, and which can be used to differentiate between otherwise identical semiconductors. A PUF can therefore be relied on to create a unique identification (ID) of a hardware device or to generate a device-specific secure key.

In yet another embodiment, the identifier (ID) generating module 220 is configured to generate the semiconductor device's unique ID using a distributed proactive polymorphic hardware. Such polymorphic hardware may include at least one polymorphic core including at least one polymorphic logic. The polymorphic logic is adapted to adjust an implementation of a proactive polymorphic model without changing the contextual functionality of the proactive polymorphic model.

The memory verification module 230 is configured to verify any pre-programmed memory 121 in the logic circuitry 120 of the semiconductor device. Such memory cannot be electronically modified after the manufacture of the device. Examples for memory types verified by the module 230 include read-only memory (ROM), a fuse array, one-time programmable (OTP) memory, and the like.

In an embodiment, the memory verification module 230 is configured to read the contents of the memory 121 and to compare such contents to data written (or intended to be written) by the manufacturer in the memory 121. The comparison may be based on a hash value computed over the stored contents. The validated contents of the memory 121 may be provided by the manufacturer. In an embodiment, before shipping the semiconductor device, the memory verification module 230 is configured to read data stored in the memory 121 and store the contents locally, so that the authenticity of the memory can be later determined. In an embodiment, the memory verification module 230 is further configured to verify that the memory operates correctly. That is, that data can be written and read from the memory.

The memory eraser module 240 is configured to erase the contents of any volatile memory 122 and certain areas in the non-volatile memory 121 in the logic circuitry 120. Erasing the contents of the volatile memories ensures that malicious software or firmware has not been implemented in the semiconductor device. It should be noted that the memory eraser module 240 is configured to erase external volatile memory, internal volatile memory, or both. It should be noted that only non-verified areas of the non-volatile memory 121 are being erased.

The implanted circuitry detection module 250 is configured to detect any circuitry added to the logic circuitry 120 by an entity other than the developer of the semiconductor device. Such circuitry may cause harm to the operation of the semiconductor device, such as leaking data, denials of service, and the like. The implanted circuitry may include hardware trojans. Hardware trojans are modifications to original circuitry inserted by malicious entities to exploit hardware or to use hardware mechanisms to gain access to data or software running on the semiconductor device. Hardware Trojans can be implemented by adding logical gates, flip-flops, or both, to the circuitry 120 typically in areas or “real estate” that are vacant in the semiconductor device. The detection of Hardware trojans may be based on power analysis, by checking if the circuitry 120 has increased from the design, timing analysis to detect clock delays, activation of free regions to detect any electric activity, and the like.

In an embodiment, the sanitization and authentication process is performed at production before the semiconductor device 100 leaves the factory and can be executed again when the semiconductor 100 reaches the customer. The sanitization activation module 270 is configured to switch the device 100 into a sanitization mode. In this mode, all flip-flops, or any combinatorial logic, are chained and enabled. A sanitization challenge signal 201 is input. The signal 201 is N bits, and the input is provided by shifting the bits through the chained logic. Next, all flip-flops are switched to a function mode, where a clock is asserted. This would allow for the propagation of the challenge signal 201 through the chained flip-flops. Then, all flip-flops are enabled, or switched back to a shift mode, and all N bits are shifted out. The output which, is the sanitization fingerprint signal 202, is captured. It should be noted that ‘N’ is an integral number. The number of bits N is a large number, such as 2\hat{ }256.

It should be noted that the flip-flops, or any combinatorial logic, are of the logic circuitry 120 and any of the modules in the sanitization circuit 110. Thus, the sanitization mode further includes scanning the activation module 210, identifier generating module 220, memory verification module 230, memory eraser module 240, and implanted circuitry detector 250.

The sanitization fingerprint 202 is correlated with the unique generated ID using the logical XOR 260. In an embodiment, the unique generated ID can be replaced with any other self-generated secret. The sanitization challenge, generated ID, and the sanitization fingerprint are sent to the database (130) over a secured connection. In another embodiment, the logical XOR 260 may be replaced by any other mathematical, logical, or cryptographic function. The sanitization fingerprint signal 202, either correlated with the ID or not, can be further encrypted or encoded using, for example, a hash function.

When running the sanitization process at production, the information, including the sanitization challenge, generated ID, and the sanitization fingerprint, is saved in a database for future use. When the sanitization process is performed for authentication at the customer's location, such information is received from the semiconductor device and matched against the respective data stored in the database 130.

Specifically, when the semiconductor device 100 is at the customer's location, the customer can execute the sanitization process by activating the semiconductor device, and the results, including the sanitization fingerprint, are compared with the respective information in the database 130. If there is a complete match, the semiconductor device is authenticated and trustworthy. When the semiconductor device is authenticated, a customer can add secret keys to the semiconductor device.

In another embodiment, the sanitization process, and the sanitization circuit 110 disclosed herein, can be utilized for a remote factory reset of the semiconductor device 100. This includes remotely activating the sanitization activation module 270 that triggers the sanitization process. At the end of the sanitization process, the device 100 returns to a “factory state” and firmware can be downloaded and stored in the device 100.

It should be noted that any of the modules illustrated in FIG. 2, can be implemented as software, hardware, or combination thereof. When implemented in hardware, any of the modules of the sanitization circuit 110, can be realized as one or more hardware logic components and circuits which can perform calculations or other manipulations of information. Software shall be construed broadly to mean any type of instructions, whether referred to as software, firmware, middleware, microcode, hardware description language, or otherwise. Instructions may include code, such as in source code format, binary code format, executable code format, or any other suitable format of code.

In an embodiment, software realizing any of the modules 210 through 260 can be a library provided by an electronic design automation (EDA) tool. This would allow for design of any semiconductor device with the functionality of the sanitization circuit 110.

It should be noted that the sanitization process can be performed at any stage of the supply chain of semiconductor devices. That is, at a completion fabrication stage, a packaging stage, and at a deployment stage, a sanitization process can be performed. It should be noted that the sanitization process is performed by the sanitization circuit 110, and that the semiconductor device being authenticated is to be placed in a system that powers the semiconductor device, feeds the sanitization challenge, captures the sanitization fingerprint, and communicates the same to the database 130. The system may be, for example, a chip test, or any general-purpose computer configured to perform the same. Such a system is configured with security modules such as, but not limited to, a hardware security module (HSM).

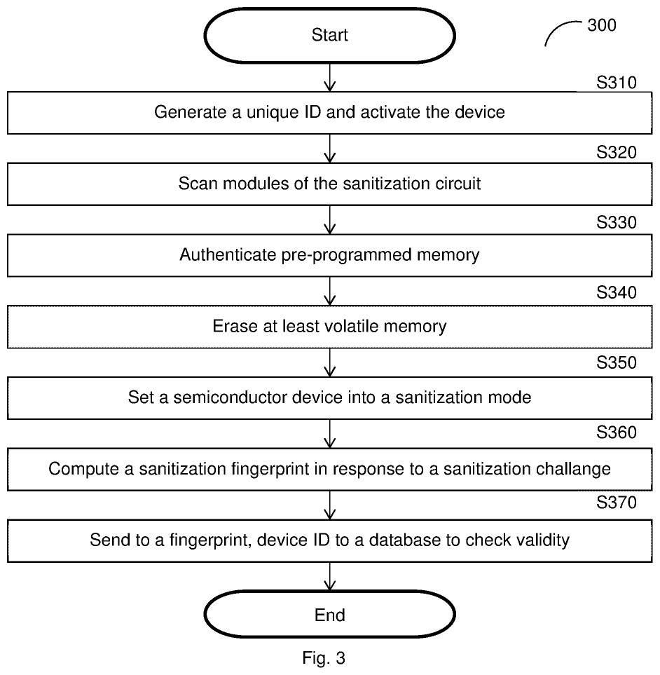

FIG. 3 shows an example flowchart 300 illustrating a method for authenticating and sanitizing a semiconductor device according to an embodiment. The method is performed when the semiconductor device is at a customer's location, and the semiconductor device's authentication status is checked. The semiconductor device includes multiple modules, such as the modules 210 through 270 of FIG. 2, memories, and other logic. The steps discussed below can be performed in parallel or sequences other than the order shown in FIG. 3.

At S310, a unique ID is generated for the semiconductor device. Further, the semiconductor device and a sanitization circuit, such as the sanitization circuit 110 of FIG. 1, in the semiconductor device is activated. In an embodiment, the activation of the semiconductor device may be performed using the unique ID or any other secret key.

At S320, each module of the sanitization circuit performs a scan to detect any potential changes made to each of these modules. The scan may include feeding an input sequence and checking if the output is an expected value. The scanning results are stored in one of the memories of the semiconductor device.

At S330, each pre-programmed memory is authenticated to determine if the contents of such memory have not been manipulated or changed. In an embodiment, S330 is performed by the memory verification module 230 as discussed in detail above. The memory authentication results are saved in the one of the memories of the semiconductor device.

At S340, any volatile memory internal or external to the semiconductor device is erased. This is to ensure that any contents saved in the volatile memory, such as a flash memory, are deleted. As malicious code can be written to the flash memory, wiping the memory provides another layer of security. The memory erasing results are saved in the one of the memories of the semiconductor device. S340 further includes deleting any unverified areas of the non-volatile memory.

At S350, a sanitization mode is triggered to determine a sanitization fingerprint in response to a sanitization challenge. In an embodiment, S350 includes chaining all flip-flops, or any combinatorial logic; enabling the flip-flops, such as by switching to a shift mode; inputting a sanitization challenge by shifting the bits of the challenge through the chained logic; switching all flip-flops to a functional mode and triggering a clock signal to propagate the challenge signal through the chained flip-flops; and enabling all flip-flops to capture the output. The output is the sanitization fingerprint.

Optionally, at S360, a sanitization fingerprint may be correlated with the device ID or any other secret. The correlation may be performed using, for example, an XOR function. In an embodiment, the sanitization fingerprint, optionally correlated with the ID, is encrypted or encoded using a hash function. An example for such a hash function may include Message Authentication Codes (MAC).

At S370, the sanitization fingerprint together with the semiconductor device's ID are sent to a database over a secured connection. The database may perform a process to compare the received sanitization fingerprint to a corresponding value saved in the database of the respective ID. In another embodiment, the database may compute a sanitization fingerprint based on a saved value of a sanitization challenge. The computed sanitization fingerprint is compared to the received sanitization fingerprint.

The various embodiments disclosed herein can be implemented as hardware, firmware, software, or any combination thereof. Moreover, the software is preferably implemented as an application and or system program tangibly embodied on a program storage unit or computer readable medium consisting of parts, or of certain devices and/or a combination of devices. The application and or system program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application or system program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A sanitization circuit for sanitizing and authenticating a semiconductor device, wherein the sanitization circuit is integrated in the semiconductor device, comprising:
a memory verification module configured to verify any pre-programmed memory integrated in the semiconductor device;
a memory eraser module configured to erase data stored in at least volatile memory accessed by the semiconductor device; and
an implanted circuitry detection module configured to detect any unintended circuitry added to the semiconductor device.

2. The sanitization circuit of claim 1, wherein the sanitization circuit further includes:
a sanitization activation module configured to operate the semiconductor device in a sanitization mode.

3. The sanitization circuit of claim 2, wherein the sanitization activation module is further configured to:
chain all flip-flops in the semiconductor device;
enable the flip-flops;
input a sanitization challenge by shifting the sanitization challenge through the chained flip-flops;
switch the chained flip-flops into a functional mode;
assert a clock signal to propagate the sanitization challenge through the chained flip-flops; and
enable the chained flip-flops to capture an output signal, wherein the output is a sanitization fingerprint.

4. The sanitization circuit of claim 3, wherein the sanitization circuit is further configured to:
correlate the sanitization fingerprint a unique ID of the semiconductor device.

5. The sanitization circuit of claim 4, wherein the sanitization fingerprint is compared to a pre-computed sanitization fingerprint, when the sanitization fingerprint matches the pre-computed sanitization fingerprint, the semiconductor device is determined to be sanitized and authentic.

6. The sanitization circuit of claim 2, wherein the sanitization circuit further includes:
an activation module configured to activate the sanitization circuit and the semiconductor device; and
an identifier generating module configured to generate a unique identifier (ID) for the semiconductor device.

7. The sanitization circuit of claim 6, wherein the activation module is further configured to: cause activation based on any one of: the sanitization circuit and the semiconductor device based on any one on: an input activation signal, an encrypted activation sequence, an identifier generated by a physical unclonable function, and a password.

8. The sanitization circuit of claim 6, wherein the identifier generating module is further configured to generate the unique ID for the semiconductor device using any one of: a PUF and a distributed proactive polymorphic hardware.

9. The sanitization circuit of claim 1, wherein the memory verification module is further configured to:
read contents of each of pre-programmed memory in the semiconductor device; and
compare the read contents to the contents written by a manufacturer of the semiconductor device.

10. The sanitization circuit of claim 1, wherein the memory eraser module is further configured to: erase areas in the non-volatile memory areas verified by the memory verification module.

11. The sanitization circuit of claim 1, wherein the implanted circuitry detection module is further configured to: detect hardware trojans potentially added to the semiconductor device based on any one of: a power analysis, a timing analysis, and activation of free regions to detect any electric activity.

12. The sanitization circuit of claim 1, wherein the sanitization circuit is configured to:
sanitize and authenticate the semiconductor device at any stage of a manufacturing of sanitization circuit.

13. The sanitization circuitry of claim 6, wherein any one of the activation module, the identifier generating module, the memory verification module, the memory eraser module, and the implanted circuitry detection module is an electronic circuit.

14. The sanitization circuitry of claim 1, wherein the sanitization circuitry is further configured to: confirm the integrity of the semiconductor device.

15. The sanitization circuit of claim 3, wherein sanitizing the semiconductor device includes removing any potential malicious software and hardware implanted in the sanitization circuit, and wherein authenticating the semiconductor device includes checking an authenticity of the semiconductor device.

16. A method for sanitizing and authenticating a semiconductor device, comprising:
activating the semiconductor device to operate in a sanitization mode;
inputting a sanitization challenge; and
capturing a sanitization fingerprint in response to the sanitization challenge, wherein the sanitization fingerprint is indicative of the authenticity of the semiconductor device.

17. The method of claim 16, further comprising:
chaining all flip-flops in the semiconductor device;
enabling the flip-flops;
inputting the sanitization challenge by shifting the sanitization challenge through the chained flip-flops;
switching the chained flip-flops into a functional mode;
asserting a clock signal to propagate the sanitization challenge to propagate through the chained flip-flops; and
enabling the chained flip-flops to capture an output signal, wherein the output is a sanitization fingerprint.

18. The method of claim 17, further comprising:
correlating the sanitization fingerprint a unique identifier of the semiconductor device.

19. The method of claim 17, further comprising:
verifying any pre-programmed memory integrated semiconductor device;
erasing contents of at least volatile memory accessed by the semiconductor device;
detecting any unintended circuitry added to the semiconductor device; and
generating a unique identifier for the semiconductor device.

20. The method of claim 17, wherein enabling the flip-flops and the chained the flip-flops further comprises:
switching the flip-flops and the chained the flip-flops into a shift mode.
